(19) United States
(12) Patent Application Publication
(10) Pub. No.: US 2025/0301376 A1
(43) Pub. Date: Sep. 25, 2025

(54) HANDOVER METHODS AND APPARATUSES

(71) Applicant: Beijing Xiaomi Mobile Software Co., Ltd., Beijing (CN)

(72) Inventor: Jianning LIU, Beijing (CN)

(73) Assignee: Beijing Xiaomi Mobile Software Co., Ltd., Beijing (CN)

(21) Appl. No.: 18/863,182

(22) PCT Filed: May 6, 2022
(86) PCT No.: PCT/CN2022/091319

§ 371 Date: Nov. 5, 2024

(51) Int. Cl. H04W 36/00; H04W 72/30

(52) U.S. Cl. CPC H04W 36/0072; H04W 72/30

(57) ABSTRACT

A handover method includes: establishing a connection to a second base station via a second UE, where the second base station provides services for the second UE; receiving first information, where the first information is configured to assist in switching from a first base station providing services for the first UE to the second base station; and transmitting second information to the first base station, where the second information includes the first information.

### CROSS REFERENCE TO RELATED APPLICATIONS

This application is a National Phase of International Application No. PCT/CN2022/091319, filed on May 6, 2022, the entire contents of which are incorporated herein by reference in their entireties.

### TECHNICAL FIELD

The present disclosure relates to the field of mobile communication technologies and in particular to handover methods and apparatuses.

### BACKGROUND

In mobile network communication system, a user equipment (UE) needs to perform network handover based on performance of a base station, for example, perform handover between a direct network communication path and an indirect network communication path. But in the current mobile network communication system, when a remote UE needs to switch from a direct network connection to an indirect network connection through a relay UE, because the relay UE and the remote UE are usually to be under the network coverage of the same base station and the remote UE can obtain a measurement value only by using broadcast signals of the base station, its handover success rate is relatively low.

### SUMMARY

The present disclosure provides handover methods and apparatuses that provide a handover mechanism from a direct network connection to an indirect network connection triggered by the UE side, such that the network handover success rate is increased and session continuity is ensured.

According to a first aspect of the embodiments of the present disclosure, there is provided a handover method, performed by a first user equipment (UE) and including: establishing a connection to a second base station via a second UE, where the second base station provides services for the second UE; receiving first information, where the first information is configured to assist in switching from a first base station providing services for the first UE to the second base station; and transmitting second information to the first base station, where the second information includes the first information.

In an embodiment, the handover method further includes: performing a relay UE discovery process to determine the second UE.

In an embodiment, the performing the relay UE discovery process to determine the second UE includes: receiving a broadcast of at least one relay UE, where the broadcast carries information supporting relay services; and selecting the second UE from the at least one relay UE.

In an embodiment, the handover method further includes, before establishing the connection to the second base station via the second UE: establishing a first connection to the second UE.

In an embodiment, the connection to the second base station via the second UE is an access (AS) connection, where the receiving the first information includes: receiving the first information from the second UE via the AS connection, where the first information includes at least one of: an identifier of the second base station, a measurement value of the second base station, or an identifier of the second UE.

In an embodiment, the second UE is a relay UE, and the relay UE includes a layer 2 UE-to-network relay UE.

In an embodiment, the method further includes: deciding to switch from the first base station to the second base station based on the first information and generate a handover instruction; where the second information further includes the handover instruction configured to instruct the first base station to perform handover.

In an embodiment, the second information further includes a handover request configured to instruct the first base station to decide to switch to the second base station based on the first information.

According to a second aspect of the embodiments of the present disclosure, there is provided a handover method, performed by a second user equipment (UE) and including: establishing a connection to a first UE and a second base station, where the second base station provides services for the second UE; determining first information, where the first information is configured to assist in switching from a first base station providing services for the first UE to the second base station; and transmitting the first information to the first UE.

In an embodiment, the handover method further includes: transmitting a broadcast to the first UE, where the broadcast carries information supporting relay services.

In an embodiment, the handover method further includes, before establishing the connection to the first UE and the second base station: establishing a first connection to the first UE.

In an embodiment, the handover method further includes, after establishing the first connection: determining a connection management state of the second UE; and switching to a connection management-connected (CM-CONNECTED) state when the second UE is in a connection management-idle (CM-IDLE) state.

In an embodiment, the connection to the first UE and the second base station is an access (AS) connection, where the transmitting the first information to the first UE includes: transmitting the first information to the first UE via the AS connection, where the first information includes at least one of: an identifier of the second base station, a measurement value of the second base station, or an identifier of the second UE.

In an embodiment, the second UE is a relay UE, and the relay UE includes a layer 2 UE-to-network relay UE.

According to a third aspect of the embodiments of the present disclosure, there is provided a handover method, performed by a first base station and including: receiving second information from a first user equipment (UE), where the second information includes first information, and the first information is configured to assist in switching from the first base station providing services for the first UE to a second base station providing services for a second UE; and switching from the first base station to the second base station based on the second information.

In an embodiment, the first information includes at least one of: an identifier of the second base station, a measurement value of the second base station, or an identifier of the second UE.

In an embodiment, the second information further includes a handover instruction, where the switching from the first base station to the second base station based on the second information includes: switching from the first base station to the second base station based on the handover instruction, where the handover instruction is generated by the first UE based on the first information.

In an embodiment, the second information further includes a handover request, where the switching from the first base station to the second base station based on the second information includes: in response to the handover request, deciding to switch to the second base station based on the first information.

In an embodiment, the handover method further includes: performing Xn-based handover process to complete handover from the first base station to the second base station based on presence of an Xn connection between the first base station and the second base station; or performing N2-based handover process to complete handover from the first base station to the second base station based on absence of the Xn connection between the first base station and the second base station or based on failure of the Xn-based handover process.

According to a fourth aspect of the embodiments of the present disclosure, there is provided a communication device, including: a transceiver, a memory storing computer-executable instructions, and a processor connected to the transceiver and the memory, respectively; where the computer-executable instructions, when executed by the processor, cause the processor to control transmitting and receiving of wireless signals of the transceiver and perform the handover method of any one of the embodiments of the first, second or third aspect.

Additional aspects and advantages of the present disclosure will be partially given in the following descriptions and partially become apparent from the following descriptions or be known by practice of the present disclosure.

### BRIEF DESCRIPTION OF THE DRAWINGS

The above and/or additional aspects and advantages of the present disclosure will become apparent and intelligible from the following descriptions of the embodiments made by referring to the drawings.

FIG. 1 is a flowchart illustrating a handover method according to an embodiment of the present disclosure.

FIG. 2 is a flowchart illustrating a handover method according to an embodiment of the present disclosure.

FIG. 3 is a flowchart illustrating a handover method according to an embodiment of the present disclosure.

FIG. 4 is a flowchart illustrating a handover method according to an embodiment of the present disclosure.

FIG. 5 is a flowchart illustrating a handover method according to an embodiment of the present disclosure.

FIG. 6 is a flowchart illustrating a handover method according to an embodiment of the present disclosure.

FIG. 7 is a flowchart illustrating a handover method according to an embodiment of the present disclosure.

FIG. 8 is a time sequence diagram illustrating a handover method according to an embodiment of the present disclosure.

FIG. 9 is a block diagram illustrating a handover apparatus according to an embodiment of the present disclosure.

FIG. 10 is a block diagram illustrating a handover apparatus according to an embodiment of the present disclosure.

FIG. 11 is a block diagram illustrating a handover apparatus according to an embodiment of the present disclosure.

FIG. 12 is a block diagram illustrating a handover apparatus according to an embodiment of the present disclosure.

FIG. 13 is a block diagram illustrating a handover apparatus according to an embodiment of the present disclosure.

FIG. 14 is a structural schematic diagram illustrating a communication device according to an embodiment of the present disclosure.

FIG. 15 is a structural schematic diagram illustrating a chip according to an embodiment of the present disclosure.

### DETAILED DESCRIPTION OF THE EMBODIMENTS

Hereinafter, the embodiments of the present disclosure will be described in detail, examples of which are illustrated in the accompanying drawings, where the same or similar reference numerals indicate the same or similar elements throughout. The embodiments described below by reference to the accompanying drawings are exemplary and are intended to explain the present disclosure and are not to be construed as limiting the present disclosure.

A cellular network-based device to device (D2D) communication, or a proximity service (ProSe) refers to the transmission of user data directly between terminals without transiting through the network. According to the service requirements defined in TS 22.278, TS 22.261, and TS 22.115 protocols, the 5th generation (5G) mobile communication technology system has been enhanced to support ProSe in TS 23.304 [17], however, a relay between user equipments (UE to UE) is not defined. With the continuous development of 5G technology, it is necessary to support path switching or base station switching between a direct network communication path and an indirect network communication path for layer-2 UE-to-network relay with session continuity consideration.

In a cellular vehicle-to-everything (C-V2X) wireless communication technology based on the cellular network, the PC5 interface is an interface for device to device (D2D) direct communication between the UEs by using the V2X service, without a base station. The Uu interface is an air interface between the vehicle model group and the base station. When the UE communicates with the base station through the relay UE, the UE is a remote UE, which communicates with the relay UE through the PC5 interface, and the relay UE communicates with the base station through the Uu interface. The connection between the relay UE and the base station is the direct network connection, and the connection between the remote UE and the base station is the indirect network connection.

When the communication capability or signal strength of the base station providing services the UE cannot meet the communication requirements, the UE can switch the base station, for example, the UE can switch from a direct connection with the source base station to an indirect connection with the target base station. In the related art, the remote UE performs a measurement and reporting procedure, receives a broadcast from the target base station via a Uu interface, and obtains a measurement value from the target base station. This procedure can be found in step 1 of clause 16.x.6.2 of TS 38.300 [15]. Afterwards, the base station decides to switch the UE to network (U2N) remote UE to a target U2N relay UE, the base station selects a target U2N relay UE which is included in the list of authorized public land mobile networks (PLMN) retrieved from the access and mobility management function (AMF) network element to select the target U2N relay UE. The source base station transmits a handover request defined in the TS 38.423 protocol, as well as at least an identifier of the U2N relay UE and a service cell identifier of the U2N relay UE. The target base station responds to the handover request acknowledge defined in TS 38.413 [19], and then performs the handover according to the relevant steps in clause 16.x.6.2 of TS 38.300 [15] and clause 4.9.1.2.2 of TS 23.502 [8]. However, this solution is formulated through the source base station to formulate the relay UE, and the UE under this solution can only obtain the measurement value directly through the broadcast signal of the base station, and cannot support the remote UE to obtain the measurement value of the target base station through the relay UE, therefore, this handover solution is limited by the fact that the remote UE and the relay UE must be in the cell range of the target base station, and the handover success rate and session continuity of this solution are subjected to certain limitations.

To this end, the present disclosure proposes handover methods and apparatuses that provide a handover mechanism from a direct network connection to an indirect network connection triggered by the UE side, such that the network handover success rate is increased and session continuity is ensured.

The handover methods and apparatuses provided by the present disclosure will be described in detail with reference to the accompanying drawings.

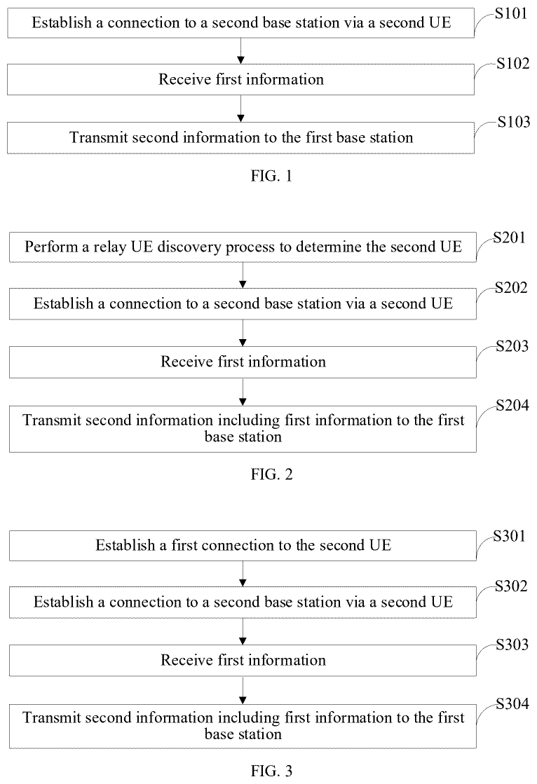

FIG. 1 is a flowchart illustrating a handover method according to an embodiment of the present disclosure. As shown in FIG. 1, the method is applied to a first User Equipment (UE) and may include the following steps S101 to S103.

At step S101, a connection to a second base station via a second UE is established.

In an embodiment of the present disclosure, the first UE may be understood as a remote UE and a first base station providing services for the first UE may be understood as a source base station, the second UE may be understood as a relay UE, and the second base station provides services for the second UE and can be understood as a target base station.

It will be understood that the relay UE includes a Layer 2 UE-to-Network Relay UE.

When the first UE decides to switch from a direct network connection to an indirect network connection, the first UE establishes a connection between the first UE and the second base station by using an appropriate L2 UE-to-network (U2N) relay UE.

In an optional embodiment, the connection is an access (AS) connection, and the AS connection may include a 3rd generation partnership project (3GPP) access and/or non-3GPP access.

At step S102, first information is received.

The first information is configured to assist in switching from the first base station providing services for the first UE to the second base station. It can be understood that the first information may assist the first UE to decide to switch from the first base station to the second base station or assist the first base station to decide to switch to the second base station.

In an embodiment of the present disclosure, the first UE may, through the established connection, receive the first information from the second UE or receive the first information in another way. In an optional embodiment, the first UE may, through the established AS connection, receive the first information from the second UE, where the first information includes at least one of: an identifier of the second base station, a measurement value of the second base station, or an identifier of the second UE. The measurement value of the second base station may be data, for example, a signal intensity of the second base station, for representing a communication capability of the second base station, and the identifier of the second base station may also be an identifier of a cell corresponding to the second base station, which is not limited herein.

In an embodiment of the present disclosure, the first information may be obtained by one message or by multiple messages. When the first information is obtained by multiple messages, the multiple messages may be received at the same time or in an order. For example, the identifier of the second base station, the measurement value of the second base station and the identifier of the second UE may be obtained by one message or obtained by multiple messages at the same time, or obtained by multiple messages separately, for example, the identifier of the second UE is obtained before connection establishment, and the identifier of the second base station or the measurement value of the second base station may be obtained after connection establishment, which is not limited herein.

The UE identifier may be a generic public subscription identifier (GPSI) or subscription permanent identifier (SUPI), which is not limited herein.

At step S103, second information is transmitted to the first base station, where the second information includes the first information.

In an embodiment of the present disclosure, the first UE may transmit the second information to the first base station through an original connection to the first base station. In the present disclosure, based on local configuration or policy of UE, the first UE may determine whether to switch from the first base station to the second base station or the first base station may determine whether to switch to the second base station. In different solutions, the second information may further include a handover instruction or handover request. The first base station completes handover in response to the second information. In other words, the first UE switches from the source base station providing services to the target base station providing services.

In some optional embodiments of the present disclosure, when the first UE determines whether to switch from the first base station to the second base station based on the local configuration or policy of UE, the first UE may, based on the received first information, determine to switch from the first base station to the second base station and generate a handover instruction included in the second information, and transmit the handover instruction together with the first information to the first base station. Thus, the first base station may directly perform handover based on the data such as the ID of the second base station in the first information in response to the handover instruction.

In some optional embodiments of the present disclosure, when the first base station determines whether to switch to the second base station based on the local configuration or policy of UE, the second information further includes a handover request, and the first UE may transmit the first information received from the second UE to the first base station together with the handover request, and the first base station may, in response to the handover request, determine to switch to the second base station and perform handover process based on the data in the first information.

Thus, in the handover method provided by the embodiments of the present disclosure, the first UE establishes the connection to the second base station via the second UE, receives the first information configured to assist in switching from the first base station providing services for the first UE to the second base station providing services for the second UE, and transmits the second information including the first information to the first base station. In this way, the network handover success rate can be increased, the session continuity can be guaranteed, and the applicable scope of the network handover is expanded.

FIG. 2 is a flowchart illustrating a handover method according to an embodiment of the present disclosure. The method applied to a first UE. Based on the embodiment shown in FIG. 1, as shown in FIG. 2, the method may include the following steps S201 to S204.

At step S201, a relay UE discovery process is performed to determine a second UE.

The first UE tries to perform L2 U2N Relay UE discovery process to select an appropriate L2 U2N Relay UE. This process can be referred to the contents specified in Clause 6.3.2.3 in TS 23.304 and will not be repeated herein. It can be understood that a UE which triggers the L2 U2N Relay discovery process becomes a Remote UE.

In an embodiment of the present disclosure, the first UE performs relay UE discovery process to determine the second UE, which may specifically include: receiving a broadcast of at least one relay UE, where the broadcast carries information supporting relay services; selecting the second UE from the at least one relay UE.

In the present disclosure, before the step S201 is performed, if the first UE has upload (UL) data or download (DL) data to transmit by a direct network connection, the first UE may, based on the local configuration or policy, determine to switch from the direct network connection to an indirect network connection. For example, when the direct network connection may not satisfy the quality of service (QOS) of the UL/DL data transmission, the first UE may be triggered to determine to try handover.

At step S202, a connection to a second base station via the second UE is established.

The second base station provides services for the second UE.

At step S203, first information is received.

The first information is configured to assist in switching from a first base station providing services for the first UE to the second base station.

At step S204, second information is transmitted to the first base station, where the second information includes the first information.

For the descriptions and details of the steps S202 to S204, reference can be made to relevant descriptions and details of the steps S101 to S103 and no redundant descriptions are made herein.

Thus, in the handover method provided by the embodiments of the present disclosure, the first UE performs relay UE discovery process to determine the second UE and hence establishes the connection to the second base station via the second UE, receives the first information configured to assist in switching from the first base station providing services for the first UE to the second base station providing services for the second UE, and transmits the second information to the first base station. This solution changes a trigger condition and a trigger subject for performing network handover by a specific relay UE specified by the source base station in the prior arts, lowering the network handover complexity, improving the network handover success rate, ensuring the session continuity, and expanding the applicable scope of the network handover.

FIG. 3 is a flowchart illustrating a handover method according to an embodiment of the present disclosure. The method may be applied to a first UE. Based on the embodiment shown in FIG. 1, as shown in FIG. 3, the method may include the following steps S301 to S304.

At step S301, a first connection to a second UE is established.

Before the first UE establishes a connection to a second base station via the second UE, the first UE establishes the first connection to the second UE. The first connection may be a PC5 connection, which is established between a remote UE and an L2 U2N relay UE. The process can be referred to the contents specified in Clause 6.4.3 in TS 23.304 and no redundant descriptions are made herein.

In an embodiment of the present disclosure, after the PC5 connection is established, a connection management-idle (CM-IDLE) state of the second UE is switched to a connection management-connected (CM-CONNECTED) state. In other words, when the L2 U2N Relay UE is in a CM-IDLE state, the establishment process of the PC5 connection may trigger a service request to be in CM-CONNECTED state.

The established PC5 connection may help establish the connection (i.e. the connection to the second base station via the second UE established by the first UE) in the step S302 below by using the L2 U2N Relay UE (i.e. the second UE) between the Remote UE (i.e. the first UE) and a target gNB (i.e. the second base station).

At step S302, a connection to the second base station via the second UE is established.

The second base station provides services for the second UE.

In an embodiment of the present disclosure, the connection to the second base station via the second UE may be an Access (AS) connection. It can be understood that after the PC5 between the first UE and the second UE is established, the connection management state of the second UE is switched to the CM-CONNECTED state, which instructs the second UE and the second base station are in connected state. At this time, the first UE may establish an AS connection to the second base station via the second UE. The AS connection is configured to transmit data and/or signaling among the first UE, the second UE and the second base station.

At step S303, first information is received.

The first information is configured to assist in switching from a first base station providing services for the first UE to the second base station.

At step S304, second information is transmitted to the first base station, where the second information includes the first information.

For the descriptions and details of the steps S302 to S304, reference may be made to the relevant descriptions and details relating to the steps S101 to S103 in the embodiment of FIG. 1 or to the steps S202 to S204 in the embodiment of FIG. 2. Thus, no redundant descriptions are made herein.

It should be noted that, although the embodiment shown in FIG. 3 is described based on the embodiment shown in FIG. 1, the embodiment shown in FIG. 3 may also be described based on the embodiment shown in FIG. 2. No redundant descriptions are made herein.

Thus, in the handover method provided by the embodiments of the present disclosure, the first UE may establish the PC5 connection to the second UE to establish the connection to the second base station via the second UE and hence receive the first information, and transmit the second information including the first information to the first base station. This solution changes the execution sequence of establishing the PC5 connection and/or AS connection and obtaining relevant data of the target base station in the prior arts, which avoids the problem of the low handover success rate resulting from obtaining the measurement value of the target base station by broadcast and then establishing relevant connection. In the present disclosure, the PC5 connection and/or AS connection is firstly established and then relevant data of the target base station is transmitted, which increases the network handover success rate while ensuring session continuity.

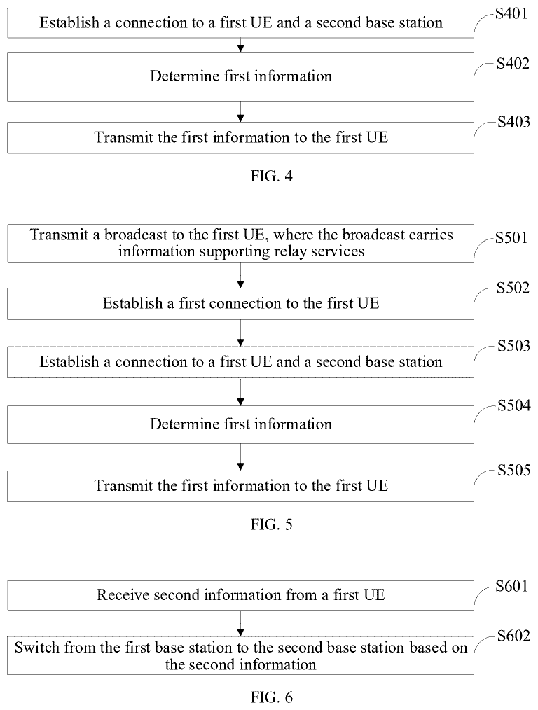

FIG. 4 is a flowchart illustrating a handover method according to an embodiment of the present disclosure. As shown in FIG. 4, the method may be applied to a second UE and may include the following steps S401 to S403.

At step S401, a connection to a first UE and a second base station is established.

In an embodiment of the present disclosure, the second UE is an appropriate L2 UE-to-Network (U2N) Relay UE that the first UE selects by performing relay UE discovery process. This process can be referred to the contents in Clause 6.3.2.3 in TS 23.304 and no redundant descriptions are made herein.

The first UE may be understood as a remote UE and a first base station providing services for the first UE may be understood as a source base station, the second UE may be understood as a relay UE, and the second base station provides services for the second UE and can be understood as a target base station.

In an embodiment of the present disclosure, the relay UE includes the Layer 2 UE-to-Network Relay UE.

It can be understood that the second UE may establish the connection to the first UE and the second base station. In other words, the connection is connected with the first UE and the second base station via the second UE.

In one optional embodiment, the connection is an access (AS) connection, and the AS connection may include a 3rd generation partnership project (3GPP) connection and/or non-3GPP connection.

At step S402, first information is determined.

It can be understood that the second UE performs first information confirmation step, where the first information is configured to assist in switching from the first base station providing services for the first UE to the second base station.

In an embodiment of the present disclosure, the information includes at least one of: an identifier of the second base station, a measurement value of the second base station, or an identifier of the second UE.

The second UE perform measurement and reporting process through an original network connection to the second base station. By receiving a measurement report from the second base station, the second UE may determine a measurement value of the second base station and determine an identifier of the second base station and an identifier of the second UE. The measurement value of the second base station may be data, for example, a signal intensity of the second base station, for representing the communication capability of the second base station, which is not limited herein.

At step S403, the first information is transmitted to the first UE.

In an embodiment of the present disclosure, the second UE may transmit the information such as the identifier of the second base station, the measurement value of the second base station and the identifier of the second UE to the first UE through the established AS connection.

It can be understood that the first information may also be obtained by the first UE in another way.

Thus, in the handover method provided by the embodiments of the present disclosure, the second UE establishes the connection to the first UE and the second base station providing services for the second UE, determines the first information, and transmits the first information to the first UE. In this solution, the network handover success rate can be effectively increased, the session continuity can be guaranteed and the applicable scope of the network handover can be expanded.

FIG. 5 is a flowchart illustrating a handover method according to an embodiment of the present disclosure. The method may be applied to a second UE. Based on the embodiment shown in FIG. 4, as shown in FIG. 5, the method may include the following steps S501 to S505.

At step S501, a broadcast is transmitted to a first UE, where the broadcast carries information supporting relay services.

In an embodiment of the present disclosure, when a UE is a UE supporting relay services, the UE may serve as a relay UE and transmit a broadcast carrying the information that it supports relay services. The first UE may receive the broadcast of at least one relay UE when trying performing relay UE discovery process, and select the second UE from the at least one relay UE as an appropriate L2 U2N Relay UE. This process can be referred to the contents in Clause 6.3.2.3 in TS 23.304 and will not be repeated herein.

At step S502, a first connection to the first UE is established.

Before the first UE establishes the connection with a second base station via the second UE, the second UE may establish a first connection to the first UE. The first connection may be a PC5 connection which is established between a remote UE (i.e. the first UE) and the L2 U2N relay UE (i.e. the second UE). The process can be referred to the contents specified in Clause 6.4.3 in TS 23.304 and will not be repeated herein.

In an embodiment of the present disclosure, after establishing the PC5 connection, the second UE may determine a connection management state. When the second UE is in a connection management-idle (CM-IDLE) state, the CM-IDLE state of the second UE is switched to a connection management-connected (CM-CONNECTED) state. In other words, when the L2 U2N relay UE is in a CM-IDLE state, the establishment process of the PC5 connection may trigger a service request to be in CM-CONNECTED state.

The established PC5 connection may help establish the connection in the step S503 below by using the L2 U2N Relay UE (i.e. the second UE) between the Remote UE (i.e. the first UE) and a target gNB (i.e. the second base station).

At step S503, a connection to the first UE and the second base station is established.

In an embodiment of the present disclosure, the connection to the second base station via the second UE may be an Access (AS) connection. It can be understood that, after the PC5 connection between the first UE and the second UE is established, the connection management state of the second UE is switched to the CM-CONNECTED state, which instructs the second UE and the second base station are in connected state. At this time, the first UE may establish an AS connection to the second base station via the second UE. The AS connection is configured to transmit data and/or signaling among the first UE, the second UE and the second base station.

At step S504, first information is determined, where the first information is configured to assist in switching from a first base station providing services for the first UE to the second base station.

At step S505, the first information is transmitted to the first UE.

For the descriptions and details of the steps S503 to S505, reference may be made to the relevant descriptions and details of the steps S401 to S403 in the embodiment shown in FIG. 4 and no redundant descriptions are made herein.

Thus, in the handover method provided by the embodiments of the present disclosure, the second UE may transmit the broadcast to assist the first UE in performing relay UE discovery process, establish the PC5 connection to the first UE to establish the connection to the first UE and the second base station providing services for the second UE, determine the first information, and transmit the first information to the first UE. This solution changes the execution sequence of establishing the PC5 connection and/or AS connection and obtaining relevant data of the target base station in the prior arts, which avoids the problem of the low handover success rate resulting from obtaining the measurement value of the target base station by broadcast and then establishing relevant connection. In the present disclosure, the PC5 connection and/or AS connection is firstly established and then relevant data of the target base station is transmitted, which increases the network handover success rate while ensuring session continuity.

FIG. 6 is a flowchart illustrating a handover method according to an embodiment of the present disclosure. As shown in FIG. 6, the method may be applied to a first base station and may include the following steps S601 to S602.

At step S601, second information is received from a first UE.

The second information includes first information, where the first information is obtained by the first UE through a connection to a second base station via a second UE and configured to assist in switching from the first base station providing services for the first UE to the base station providing services for the second UE.

In an embodiment of the present disclosure, the first UE may be understood as a remote UE, the first base station providing services for the first UE may be understood as a source base station, the second UE may be understood as a relay UE, and the second base station providing services for the second UE can be understood as a target base station.

It can be understood that the relay UE includes a Layer 2 UE-to-Network Relay UE.

When the first UE determines to switch from a direct network connection to an indirect network connection, the first UE may establish a connection between the first UE and the second base station by using an appropriate L2 UE-to-Network (U2N) Relay UE.

In an embodiment of the present disclosure, the first UE may receive the first information from the second UE through the established connection. The connection is an access (AS) connection, and the AS connection may include a 3rd generation partnership project (3GPP) access and/or non-3GPP access.

In one optional embodiment, the first UE may receive the first information from the second UE through the established AS connection, and the first UE may also obtain the first information in another way. The first information includes at least one of: an identifier of the second base station, a measurement value of the second base station or an identifier of the second UE. The measurement value of the second base station may be data, for example, a signal intensity of the second base station, for representing a communication capability of the second base station, which is not limited herein.

In an embodiment of the present disclosure, the first base station may receive the second information through an original connection to the first UE.

At step S602, based on the second information, the first base station providing services for the first UE is switched to the second base station.

In the embodiments of the present disclosure, based on the local configuration or policy of UE, the first UE may determine whether to switch from the first base station to the second base station or the first base station may determine whether to switch to the second base station such that the first base station can, based on the received information, determine whether/how to switch data flow from the direct network connection to the indirect network connection. In different solutions, the second information may further include a handover instruction or handover request. The first base station completes handover based on the second information. In other words, the first UE switches from the source base station providing services to the target base station providing services.

In some optional embodiments of the present disclosure, when the first UE determines whether to switch from the first base station to the second base station based on the local configuration or policy of UE, the first UE may, based on the received first information, determine to switch from the first base station to the second base station and generate a handover instruction included in the second information, and transmit the handover instruction together with the first information to the first base station. Thus, the first base station may directly perform handover based on the data such as the ID of the second base station in the first information in response to the handover instruction.

In some optional embodiments of the present disclosure, when the first base station determines whether to switch to the second base station based on the local configuration or policy of UE, the second information further includes a handover request, and the first UE may transmit the first information received from the second UE to the first base station together with the handover request, and the first base station may, in response to the handover request, determine to switch to the second base station and perform handover process based on the data in the first information.

In an embodiment of the present disclosure, when the first information satisfies a preset condition, the first base station may determine to switch to the second base station.

For example, when the received measurement value of the second base station satisfies the quality of service (QOS) of UL/DL data transmission, the network connection between the first UE and the first base station is switched to the network connection between the first UE and the second base station based on the identifier of the second base station and the identifier of the second UE, and in other words, the first base station providing services for the first UE is switched to the second base station providing services for the first UE.

In the present disclosure, for the specific implementation in which the first base station, based on the received information, determines whether to switch, reference can be made to the handover condition in the prior arts and no limitation is made herein.

To sum up, in the handover method provided by the embodiments of the present disclosure, the first base station providing services for the first UE can receive the second information from the first UE, and based on the second information, determine whether to switch from the first base station providing services for the first UE to the second base station. The second information includes the first information, and the first information is obtained by the first UE through the connection to the second base station via the second UE, where the second base station provides services for the second UE. This solution improves the network handover success rate, ensures the session continuity, avoids the limitation for the handover environment in the prior arts and expands the applicable scope of the network handover.

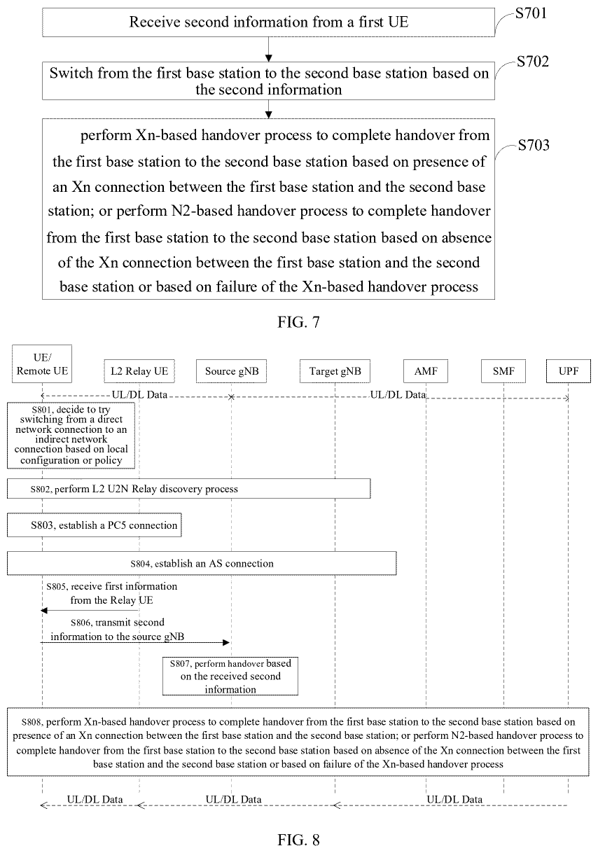

FIG. 7 is a flowchart illustrating a handover method according to an embodiment of the present disclosure. The method may be applied to a first base station. Based on the embodiment shown in FIG. 6, as shown in FIG. 7, the method may include steps S701 to S703.

At step S701, second information is received from a first UE.

At step S702, based on the second information, a first base station providing services for the first UE is switched to a second base station.

For the descriptions and details relating to the steps S701 to S702, reference can be made to the descriptions and details of the steps S601 to S602 in the embodiment shown in FIG. 6, and no redundant descriptions are made herein.

At step S703, based on presence of an Xn connection between the first base station and the second base station, Xn-based handover process is performed to complete handover from the first base station to the second base station; or, based on absence of the Xn connection between the first base station and the second base station or failure of the Xn-based handover process, N2-based handover process is performed to complete handover from the first base station to the second base station.

In an embodiment of the present disclosure, based on the information received in the step S701, the first base station performs the handover process of switching the data of the remote UE from the source base station (the first base station) to the target base station (the second base station). When the Xn connection is present between the source base station and the target base station, the first base station may perform the Xn-based handover (HO) flow to complete the step of switching from the first base station to the second base station. This process can be referred to the contents in Clause 4.9.1.2.2 in TS 23.502 and no redundant descriptions are made herein.

In an embodiment, when the Xn connection is not present between the source base station and the target base station, or when the Xn-based handover process fails, the first base station may perform N2-based HO flow to switch from the first base station to the second base station. This process can be referred to the contents in Clauses 4.9.1.3.3 and 4.9.1.3.2 in TS 23.502 and will not be repeated herein.

To sum up, in the handover method provided by the embodiments of the present disclosure, the first base station receives the information from the first UE, where the information is received by the first base station through the indirect network connection to the second base station (i.e. target base station) via the second UE; then the first base station, based on the received information, determines whether to switch network service for the first UE, which avoids the problem of the low handover success rate resulting from that the source base station specifies a relay UE to firstly perform inter-base-station handshake and then establish data transmission connection in the prior arts. In the solutions of the present disclosure, the network handover success rate can be increased while the session continuity is guaranteed; and the limitation that the remote UE can complete handover only under the signal coverage of the target base station is eliminated, expanding the applicable scope of the network handover.

FIG. 8 is a time sequence diagram illustrating a handover method according to an embodiment of the present disclosure. The method may be applied to a handover system. This handover system includes a first UE, a second UE, a first base station and a second base station. The first UE may be understood as remote UE, the first base station providing services for the first UE may be understood as source base station (source gNB), the second UE may be understood as relay UE (L2 Relay UE), and the second base station providing services for the second UE may be understood as target base station (Target gNB). The handover system further involves an Access and Mobility Management Function (AMF) network element, a Session Management function (SMF) network element, and The User plane function (UPF) network element, which are all 5G core network elements. No detailed descriptions will be made herein.

It is supposed that the UE has UL/DL (upload/download) data to transmit by a direct network connection. As shown in FIG. 8, the method may include the following steps S801 to S808.

At step S801, based on local configuration or policy, the UE determines to try switching from a direct network connection to an indirect network connection, for example, when the direct network connection does not satisfy the QoS of the UL/DL data transmission.

At step S802, the UE tries performing L2 U2N Relay discovery process to select an appropriate L2 U2N Relay UE.

In an embodiment of the present disclosure, this process may be referred to the contents in Clause 6.3.2.3 in TS 23.304 and will not be repeated herein. It can be understood that a UE which triggers performing L2 U2N Relay discovery process becomes a Remote UE.

In an embodiment of the present disclosure, the Remote UE performs the Relay UE discovery process to determine an appropriate Relay UE, which is carried out in the following way: the Remote UE receives a broadcast of at least one Relay UE, where the broadcast carries information supporting relay services; the Remote UE selects one from the at least one Relay UE as the appropriate L2 U2N Relay UE.

It can be understood that in the embodiments of the present disclosure, the Relay UE includes a Layer 2 UE-to-Network Relay UE.

At step S803, a PC5 connection between the Remote UE and the Relay UE is established.

It should be noted that the process can proceed as shown in the contents in Clause 6.4.3 in TS 23.304 and will not be repeated herein.

In an embodiment of the present disclosure, when the PC5 connection is established, the Relay UE determines whether it is connected with the target base station; when the Relay UE is in Connection Management-Idle (CM-IDLE) state, the CM-IDLE state is switched to a Connection Management-CONNECTED (CM-CONNECTED) state. In other words, when the L2 U2N Relay UE is in CM-IDLE state, the establishment process of the PC5 connection will trigger a Service Request to be in CM-CONNECTED state.

At step S804, a connection between the Remote UE and the target gNB is established by using the L2 U2N Relay UE.

In one optional embodiment, this connection is an access (AS) connection, and the AS connection may include a 3rd generation partnership project (3GPP) access and/or non-3GPP access.

In an embodiment of the present disclosure, the connection established by L2 U2N Relay UE between the Remote UE and the target gNB may be an AS connection. It can be understood that after the PC5 connection between the Remote UE and the Relay UE is established, the connection management state of the relay UE is switched to the CM-CONNECTED state, which instructs that the Relay UE and the target gNB are in connected state. At this time, the Remote UE may establish the AS connection to the target gNB via the Relay UE. This AS connection is configured to transmit data and/or signaling among the Remote UE, the Relay UE, and the target gNB.

At step S805, the Remote UE receives first information from the Relay UE.

The first information is configured to assist in switching from the source base station providing services for the Remote UE to the target base station.

In an embodiment of the present disclosure, the Remote UE may receive the first information from the Relay UE through the established AS connection. In one optional embodiment, the information includes at least one of an identifier of the target base station, a measurement value of the target base station, and an identifier of the Relay UE, that is, target gNB ID, target gNB values, and L2 U2N Relay UE ID and the like. The measurement value of the target base station may be data, for example, a signal intensity of the target base station, for representing the communication capability of the target base station. The identifier of the target base station may also be an identifier (Cell ID) of a cell corresponding to the target base station, which is not limited herein.

At step S806, the Remote UE transmits second information to the source gNB to determine handover to the target gNB.

In an embodiment of the present disclosure, the remote UE may transmit the second information to the source base station through an original connection to the source base station, where the second information includes the first information which is configured to assist switching from the source base station to the target base station; in this way, the source base station may, based on the received second information, determine whether/how to switch the data flow from the direct network connection to the indirect network connection. In other words, the remote UE switches from the source base station providing services to the target base station providing services.

At step S807, the source gNB, based on the received second information, determines to switch the data of the remote UE from the source gNB to the target gNB.

In an embodiment of the present disclosure, based on the local configuration or policy of UE, the remote UE may determine whether to switch from the source base station to the target base station, or the source base station determines whether to switch to the target base station, such that the source base station can, based on the received information, determine whether/how to switch the data flow from the direct network connection to the indirect network connection. In different solutions, the second information may further include a handover instruction or handover request. The source base station completes handover in response to the second information. In other words, the remote UE switches from the source base station providing services to the target base station providing services.

In some optional embodiments of the present disclosure, when the first UE determines whether to switch from the source base station to the target base station based on the local configuration or policy of UE, the remote UE may, based on the received information, determine to switch from the source base station to the target base station and generate a handover instruction included in the second information, and then transmit the handover instruction together with the first information to the source base station. The source base station, in response to the received handover instruction, directly performs handover based on the data such as target base station ID in the first information.

In some optional embodiments of the present disclosure, when the source base station determines whether to switch to the target base station based on the local configuration or policy of UE, the second information further includes a handover request and the remote UE may transmit the first information received from the relay UE together with the handover request to the source base station. The source base station, in response to the handover request, determines to switch to the target base station and perform handover process based on the data in the first information.

In an embodiment of the present disclosure, when the first information satisfies a preset condition, the source base station may determine to switch to the target base station.

For example, when the received measurement value of the target base station satisfies the quality of service (QOS) of the UL/DL data transmission, the network connection between the remote UE and the source base station is switched to the network connection between the remote UE and the target base station based on the identifier of the target base station and the identifier of the relay UE, and in other words, the source base station providing services for the remote UE is switched to the target base station providing services for the remote UE.

In the present disclosure, the specific implementation in which the source base station determines whether to switch based on the received information can be referred to the handover condition in the related arts and will not be limited herein.

At step S808, based presence of an Xn connection between the source base station and the target base station, Xn-based handover process is performed between the source base station and the target base station to complete handover from the source base station to the target base station; or based on absence of the Xn connection between the source base station and the target base station, or failure of the Xn-based handover process, N2-based handover process is performed between the source base station and the target base station to complete handover from the source base station to the target base station.

In an embodiment of the present disclosure, the source base station, based on the information received in the step, determines to switch the data of the remote UE from the source base station to the target base station. When the Xn connection is present between the source base station and the target base station, the source base station may perform Xn-based handover (HO) flow to complete handover from the source base station to the target base station. This process can be referred to the contents in Clause 4.9.1.2.2 in TS 23.502 and will not be repeated herein.

In an embodiment, when the Xn connection is present between the source base station and the target base station, or when the Xn-based handover process fails, the source base station may perform N2-based HO flow to switch from the source base station to the target base station. This process can be referred to the contents in Clause 4.9.1.3.2 and 4.9.1.3.3 in TS 23.502 and will not be repeated herein.

Thus, in the handover methods provided by the embodiments of the present disclosure, the problem of the low handover success rate resulting from that the source base station specifies a relay UE to firstly perform inter-base-station handshake and then establish data transmission connection in the prior arts can be avoided. In the solutions of the present disclosure, the network handover success rate can be increased while the session continuity is guaranteed; and the limitation that the remote UE can complete handover only under the signal coverage of the target base station is eliminated, expanding the applicable scope of the network handover.

In the embodiments of the present disclosure, the methods provided by the embodiments of the present disclosure are introduced respectively from the perspectives of network equipment and user equipment. In order to implement the functions of the methods provided by the embodiments of the present disclosure, the network equipment and the user equipment may include a hardware structure and a software module to implement the functions in the form of hardware structure, software module or combination of hardware structure and software module. One of the functions can be implemented in the form of hardware structure, software module or combination of hardware structure and software module.

Corresponding to the handover methods provided in the embodiments, the present disclosure also provides handover apparatuses. As the handover apparatuses provided in the present disclosure corresponds to the handover methods provided in the embodiments, the implementation of the handover methods are also applicable to the handover apparatuses provided in the embodiments and will not be described in detail in the embodiments.

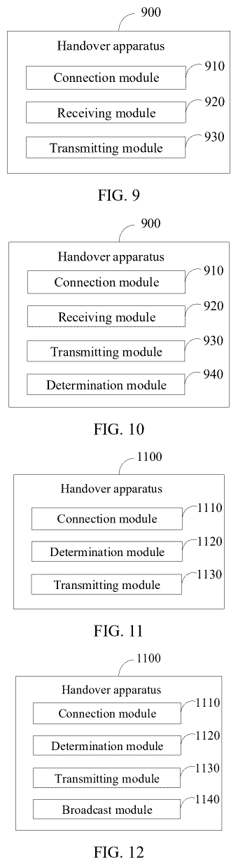

FIG. 9 is a block diagram illustrating a handover apparatus 900 according to an embodiment of the present disclosure. The handover apparatus 900 may be applied to a first user equipment (UE).

As shown FIG. 9, the handover apparatus 900 includes: a connection module 910, configured to establish a connection to a second base station via a second UE, where the second base station provides services for the second UE; a receiving module 920, configured to receive first information, where the first information is configured to assist in switching from a first base station providing services for the first UE to the second base station; and a transmitting module 930, configured to transmit second information to the first base station, where the second information includes the first information.

One or more embodiments of the present disclosure provide a handover apparatus. A first UE establishes a connection to a second base station via a second UE to receive the first information which is configured to instruct the first UE desires to switch from a first base station providing services for the first UE to the second base station providing services for the second UE, and transmit the information to the first base station, so as to increase network handover success rate, ensure session continuity and expand the applicable scope of the network handover.

In some embodiments, the connection is an access (AS) connection, and the receiving module 920 receives the first information from the second UE via the AS connection, where the first information includes at least one of: an identifier of the second base station, a measurement value of the second base station, or an identifier of the second UE.

In some embodiments, the second UE is a relay UE, and the relay UE includes a layer 2 UE-to-network relay UE.

In some embodiments, as shown in FIG. 10, the handover apparatus 900 as shown and described in detail with respect to FIG. 9, further includes a determination module 940, configured to perform a relay UE discovery process to determine the second UE.

In some embodiments, the determination module 940 is specifically configured to: receive a broadcast of at least one relay UE, where the broadcast carries information supporting relay services; and select the second UE from the at least one relay UE.

In some embodiments, the connection module 910 is configured to, before establishing the connection to the second base station via the second UE: establish a first connection to the second UE.

In some embodiments, the method further includes: deciding to switch from the first base station to the second base station based on the first information and generate a handover instruction; where the second information further includes the handover instruction configured to instruct the first base station to perform handover.

In some embodiment, the second information further includes a handover request configured to instruct the first base station to decide to switch to the second base station based on the first information.

According to one or more embodiments, the handover apparatus is provided. The first UE performs a relay UE discovery process to determine the second UE. The first UE can establish a PC5 connection to the second UE, thereby establishing a connection to the second base station via the second UE. The first UE receives the first information and transmits the second information including the first information to the first base station. This solution changes the triggering conditions and triggering subjects for the network handover specified by the source base station in related art. It also changes the execution order of establishing PC5 and/or AS connections and obtaining the relevant data of the target base station in related art, avoiding the problem of low handover success rate caused by broadcasting target base station measurement values before establishing related connections. Instead, the PC5 and/or AS connections are established first and then the relevant data of the target base station is transmitted. In this way, the network handover success rate can be increased, the session continuity can be guaranteed, and the applicable scope of the network handover is expanded.

FIG. 11 is a block diagram illustrating a handover apparatus 1100 according to an embodiment of the present disclosure. The handover apparatus 1100 is applied to a second user equipment (UE).

As shown in FIG. 11, the handover apparatus 1100 may include: a connection module 1110, configured to establish a connection to a first UE and a second base station, where the second base station provides services for the second UE; a determination module 1120, configured to determine first information, where the first information is configured to assist in switching from a first base station providing services for the first UE to the second base station; and a transmitting module 1130, configured to transmit the first information to the first UE.

According to one or more embodiments, the handover apparatus is provided. The second UE establishes the connection to the first UE and the second base station providing services for the second UE, determines the first information, and transmits the first information to the first UE. In this way, the network handover success rate can be increased, the session continuity can be guaranteed, and the applicable scope of the network handover is expanded.

In some embodiments, the connection is an access (AS) connection, the transmitting module 1130 is specifically configured to: transmit the first information to the first UE via the AS connection, where the first information includes at least one of: an identifier of the second base station, a measurement value of the second base station, or an identifier of the second UE.

In some embodiments, the second UE is a relay UE, and the relay UE includes a layer 2 UE-to-network relay UE.

In some embodiments, as shown in FIG. 12, the handover apparatus 1100 as shown and described in detail with respect to FIG. 11, further includes a broadcast module 1140, configured to transmit a broadcast to the first UE, where the broadcast carries information supporting relay services.

In some embodiments, the connection module 1110 is further configured to, before establishing the connection to the first UE and the second base station: establish a first connection to the first UE.

In some embodiments, the method may further include, after establishing the first connection: determining a connection management state of the second UE; and switching to a connection management-connected (CM-CONNECTED) state when the second UE is in a connection management-idle (CM-IDLE) state.

According to the handover apparatus provided in the embodiments of the present disclosure, the second UE may assist the first UE in performing the relay UE discovery process by transmitting a broadcast, and establish a connection to the first UE and the second base station providing services for the second UE by establishing a PC5 connection to the first UE, and determine the first information, as well as transmit the first information to the first UE. This solution changes the execution order of establishing a PC5 connection and/or AS connection and obtaining the relevant data of the target base station in related arts, avoiding the problem of low handover success rate caused by obtaining measurement values of the target base station through broadcasting and establishing relevant connections.

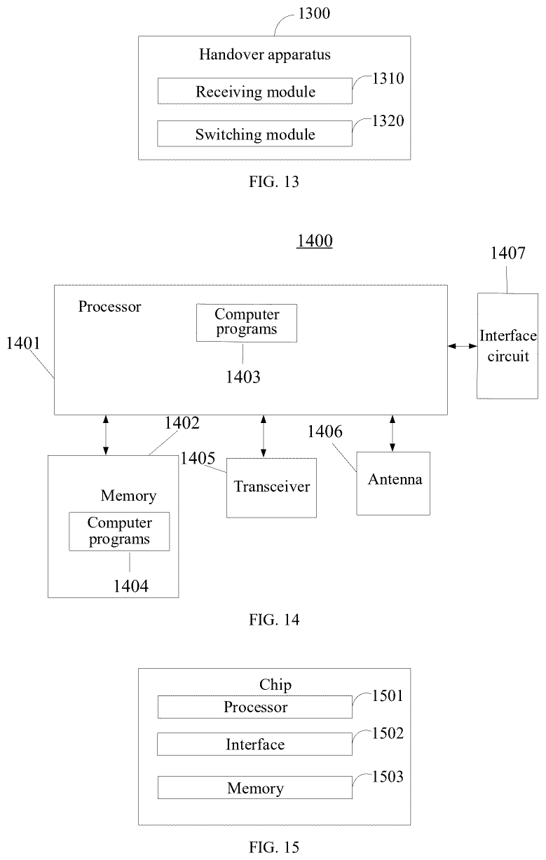

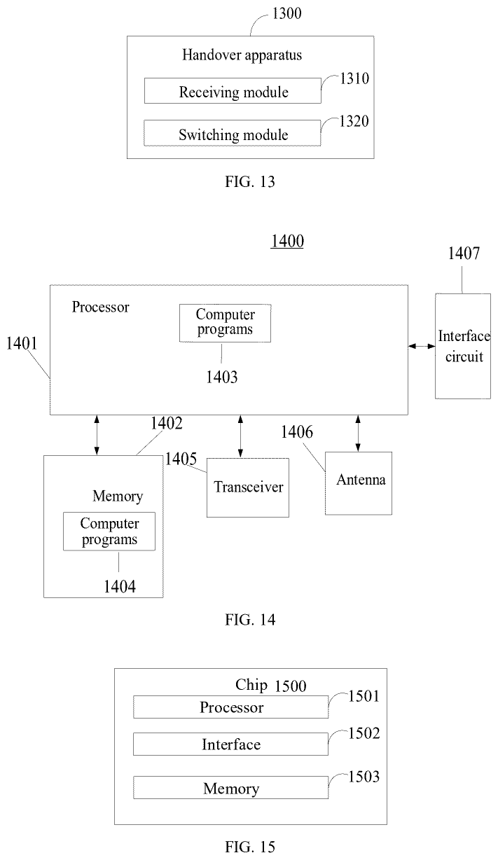

FIG. 13 is a block diagram illustrating a handover apparatus 1300 according to an embodiment of the present disclosure. The handover apparatus 1300 may be applied to a first base station.

As shown FIG. 13, the handover apparatus 1300 may include: a receiving module 1310, configured to receive second information from a first user equipment (UE), where the second information includes first information, and the first information is configured to assist in switching from the first base station providing services for the first UE to a second base station providing services for a second UE; and a switching module 1320, configured to switch from the first base station to the second base station based on the second information.

According to the handover apparatus provided in the embodiments of the present disclosure, the first base station providing services for the first UE can receive the second information transmitted by the first UE and perform a switching process from the first base station to the second base station based on the second information, where the second information includes the first information, and the first information is configured to assist in switching from the first base station providing services for the first UE to the second base station. The solution improves the success rate of network handover, ensures session continuity, avoids restrictions on the handover environment in the related art, and expands the application scope of network handover.

In some embodiments, the first information includes at least one of: an identifier of the second base station, a measurement value of the second base station, or an identifier of the second UE.

In some embodiments, the second information further includes a handover instruction, where the switching from the first base station to the second base station based on the second information includes: switching from the first base station to the second base station based on the handover instruction, where the handover instruction is generated by the first UE based on the first information.

In some embodiments, the second information further includes a handover request, where the switching from the first base station to the second base station based on the second information includes: in response to the handover request, deciding to switch to the second base station based on the first information.

In some embodiments, the switching module 1320 is configured to perform Xn-based handover process to complete handover from the first base station to the second base station based on presence of an Xn connection between the first base station and the second base station; or perform N2-based handover process to complete handover from the first base station to the second base station based on absence of the Xn connection between the first base station and the second base station or based on failure of the Xn-based handover process.

According to the handover apparatus provided in the embodiments of the present disclosure, the first base station receives information sent by the first UE and decides whether to switch network services for the first UE based on this information, avoiding the problem of low handover success rate caused by the source base station specifying a relay UE, first performing inter base station handshake, and then establishing data transmission connection in related art. The solution can improve the network handover success rate, ensure session continuity, and at the same time eliminate the limitation that remote UE needs to complete the handover within the signal coverage range of the target base station, and the applicable scope of the network handover is expanded.

One or more embodiments of the present disclosure also provide a handover system that includes: a first UE of the embodiments of FIGS. 9 to 10; a second UE of the embodiments of FIGS. 11 to 12; and a first base station of the embodiments of FIG. 13. The handover system also includes a second base station (not shown) providing services for the second UE, which is configured to perform a handover method as shown in the embodiment of FIG. 8.

FIG. 14 is a structural schematic diagram illustrating a communication device 1400 according to an embodiment of the present disclosure. The communication device 1400 may be a network device, a user equipment, a chip, a chip system, or a processor, etc. that supports the network device to realize the method, or a chip, a chip system, or a processor, etc. that supports the user equipment to realize the method. This device can be used to implement the methods described in the method embodiments, which can be referred to in the description of the method embodiments.

The communication device 1400 may include one or more processors 1401. The processor 1401 may be a general purpose processor or a specialized processor, etc. For example, the processor 1401 may be a baseband processor or a central processing unit. The baseband processor can be used to process communication protocols and communication data, and the central processing unit can be used to control communication devices (such as base stations, baseband chips, terminal devices, terminal equipment chips, DU or CU, etc.), execute computer programs, and process data of computer programs.

In an embodiment, the communication device 1400 may further include one or more memories 1402, on which computer programs 1404 may be stored, and the processor 1401 executes the computer programs 1404, so that the communication device 1400 can perform the methods described in the method embodiments. In an embodiment, data can also be stored in the memory 1402. The communication device 1400 and the memory 1402 may be set separately or integrated together.

In an embodiment, the communication device 1400 may also include a transceiver 1405 and an antenna 1406. The transceiver 1405 can be called a transceiver unit, a transceiver device, a transceiver circuit, etc., and is used to realize the transmitting and receiving function. The transceiver 1405 may include a receiver and a transmitter. The receiver may be called a receiver device or a receiving circuit, etc., for realizing the receiving function. The transmitter can be called a transmitter device or a transmitting circuit, etc., and is used to realize the transmitting function.

In an embodiment, the communication device 1400 may also include one or more interface circuits 1407. The interface circuit 1407 is used to receive code instructions and transmit the code instructions to the processor 1401. The processor 1401 executes code instructions to cause the communication device 1400 to perform the methods in any of the method embodiments.

In an embodiment, the processor 1401 may include a transceiver for implementing the receiving and transmitting functions. For example, the transceiver can be a transceiver circuit, or an interface, or an interface circuit. Transceiver circuits, interfaces or interface circuits for receiving and transmitting functions can be separated or integrated. The transceiver circuit, interface or interface circuit can be used for reading and writing codes/data, or the transceiver circuit, interface or interface circuit can be used for signal transmission or transfer.

In an implementation, the processor 1401 can store computer programs 1403, and the computer programs 1403 runs on the processor 1401, which can cause the communication device 1400 to perform the methods in the method embodiments. The computer programs 1403 may be solidified in the processor 1401, in this case, the processor 1401 may be implemented by the hardware.

In an implementation, the communication device 1400 may include a circuit, which may realize the transmitting or receiving or communicating function in the method embodiments. The processor and the transceiver described in the present disclosure can be implemented on an integrated circuit (IC), an analog IC, a radio frequency integrated circuit (RFIC), a mixed-signal IC, an application specific integrated circuit (ASIC), a printed circuit board (PCB), an electronic device, and the like. The processor and the transceiver can also be manufactured by various IC process technologies, such as a complementary metal oxide semiconductor (CMOS), a nMetal-oxide-semiconductor (NMOS), a positive channel metal oxide semiconductor (PMOS), a bipolar junction transistor (BJT), a bipolar CMOS (BiCMOS), a silicon germanium (SiGe), a gallium arsenide (GaAs), etc.

The communication device in the embodiments may be a network device or a user equipment, but the scope of the communication device described in the present disclosure is not limited thereto, and the structure of the communication device may not be limited by FIG. 14. The communication device may be a stand-alone device or may be part of a larger device. For example, the communication device may be: (1) independent integrated circuit (IC), or chip, or chip system or subsystem; (2) one or more IC sets, optionally, the IC set may also include storage components for storing data and computer programs; (3) ASIC, such as a modem; (4) modules that can be embedded in other devices; (5) a receiver, a terminal device, an intelligent terminal device, a cellular phone, a wireless device, a handset, a mobile unit, an on-board device, a network device, a cloud device, an artificial intelligence device, etc.; and/or (6) others and so on.

Referring to the structural schematic diagram of the chip shown in FIG. 15, the communication device can be a chip or a chip system. The chip 1500 shown in FIG. 15 includes a processor 1501 and an interface 1502. The number of processors 1501 may be one or more, and the number of interfaces 1502 may be plural.

The chip 1500 also includes a memory 1503, which is used to store necessary computer programs and data.

Those skilled in the art can also understand that various illustrative logical blocks and steps listed in the embodiments of the present disclosure can be implemented by an electronic hardware, a computer software, or a combination of both. Whether this function is realized by hardware or software depends on the specific application and the design requirements of the whole system. Those skilled in the art can use different methods to realize the described functions for each specific application, but this realization should not be considered beyond the scope of the technical solutions of the embodiments of the present disclosure.

The present disclosure also provides a non-transitory computer-readable storage medium having stored thereon instructions which, when executed by a computer, realize the functions of any of the method embodiments.

The present disclosure also provides a computer program product which, when executed by a computer, realizes the functions of any of the method embodiments.

In the examples, it can be implemented in whole or in part by software, hardware, firmware, or any combination thereof. When implemented in software, it can be implemented in whole or in part in the form of a computer program product. The computer program product includes one or more computer programs. When computer programs are loaded and executed on a computer, the processes or function according to the examples of the present disclosure are generated in whole or in part. The computer can be a general-purpose computer, a dedicated computer, a computer network, or other programmable devices. Computer programs can be stored in a non-transitory computer-readable storage medium or transmitted from one non-transitory computer-readable storage medium to another non-transitory computer-readable storage medium, for example, the computer programs can be transmitted from a website site, a computer, a trajectory prediction device or a data center via wire (For example, coaxial cable, optical fiber, digital subscriber line (DSL)) or wireless (for example, infrared, wireless, microwave, etc.) to another website, a computer, a trajectory prediction device, or a data center. The non-transitory computer-readable storage medium can be any available medium that can be accessed by a computer or a data storage device including one or more available devices, data centers, and the like. The available media may be a magnetic media (e.g., a floppy disk, a hard disk, a tape), an optical media (e.g., a high-density digital video disc (DVD)), or a semiconductor media (e.g., a solid-state disk (SSD)), and the like.

The person with ordinary skill in the art may understand that the first, second and other various numerical numbers involved in the present disclosure are only described for the convenience of differentiation, and are not used to limit the scope of the embodiments of the present disclosure, and also indicate the order of precedence.

The “at least one” of the present disclosure can also be described as one or more, and the “plurality” can be two, three, four or more, and the present disclosure is not limited. In the embodiments of the present disclosure, for technical features, the technical features are distinguished by “first”, “second”, “third”, “a”, “b”, “c” and “d”.

As used in this article, the terms “machine-readable medium” and “computer-readable medium” refer to any computer program product, device, and/or apparatus (e.g., disk, optical disk, memory, programmable logic device (PLD)) used to provide machine instructions and/or data to a programmable processor, including machine-readable media that receive machine instructions as machine-readable signals. The term “machine readable signal” refers to any signal used to provide machine instructions and/or data to a programmable processor.

The systems and technologies described herein can be implemented in computing systems that include backend components (such as data servers), middleware components (such as application servers), frontend components (such as user computers with graphical user interfaces or web browsers, through which users can interact with the implementation of the systems and technologies described herein), or any combination of such backend components, middleware components, or frontend components. The components of the system can be interconnected through any form or medium of digital data communication, such as a communication network. Examples of communication networks include a LAN, a WAN, and the Internet.

The computing system can include clients and servers. A client and server are generally remote from each other and typically interact through a communication network. A client-server relationship is created by computer programs that run on corresponding computers and have a client-server relationship with each other.

It will be understood that steps can be reordered, added or deleted using the various forms of flow shown. For example, the steps described in the present disclosure can be executed in parallel, sequentially or in a different order, so long as the desired results of the technical scheme disclosed in this disclosure can be achieved, there is no restriction here.

In addition, it will be understood that various embodiments described in this application can be implemented separately or in combination with other embodiments if the scheme allows.

Those skilled in the art can realize that the units and algorithm steps described in the embodiments disclosed in this article can be implemented through electronic hardware, or a combination of computer software and electronic hardware. Whether a function is performed as hardware or computer software driving hardware depends on the particular application and design constraints of the technical solution. Those skilled in the art can use different methods to realize the described functions for each specific application, but this realization should not be considered beyond the scope of the technical solutions of the embodiments of the present disclosure.

A person skilled in the art can clearly understand that, for the convenience and simplicity of description, the specific working processes of the system, apparatus and unit described may refer to corresponding processes in the foregoing method embodiments, and details are not described herein again.

The descriptions are only specific examples of the present disclosure, but the scope of protection of the present disclosure is not limited to the descriptions. Any person skilled in the art may easily conceive of changes or substitutions within the technical scope disclosed in the present disclosure, and such changes and substitutions shall fall within the protection scope of the present disclosure. Therefore, the protection scope of the present disclosure shall be subject to the protection scope of the claims.

1. A handover method, performed by a first user equipment (UE) and comprising:
establishing a connection to a second base station via a second UE, wherein the second base station provides services for the second UE;
receiving first information, wherein the first information is configured to assist in switching from a first base station providing services for the first UE to the second base station; and
transmitting second information to the first base station, wherein the second information comprises the first information.

2. The handover method of claim 1, further comprising:
performing a relay UE discovery process to determine the second UE.

3. The handover method of claim 2, wherein the performing the relay UE discovery process to determine the second UE comprises:
receiving a broadcast of at least one relay UE, wherein the broadcast carries information supporting relay services; and
selecting the second UE from the at least one relay UE.

4. The handover method of claim 1, further comprising, before establishing the connection to the second base station via the second UE:
establishing a first connection to the second UE.

5. The handover method of claim 1,
wherein the connection to the second base station via the second UE is an access (AS) connection, and
wherein the receiving the first information comprises:
receiving the first information from the second UE via the AS connection, and wherein the first information comprises at least one of: an identifier of the second base station, a measurement value of the second base station, or an identifier of the second UE.

6. The handover method of claim 1, wherein the second UE is a relay UE, and the relay UE comprises a layer 2 UE-to-network relay UE.

7. The handover method of claim 1, further comprising:
deciding to switch from the first base station to the second base station based on the first information and generating a handover instruction, and
wherein the second information further comprises the handover instruction configured to instruct the first base station to perform a handover.

8. The handover method of claim 1, wherein the second information further comprises a handover request configured to instruct the first base station to decide to switch to the second base station based on the first information.

9. A handover method, performed by a second user equipment (UE) and comprising:
establishing a connection to a first UE and a second base station, wherein the second base station provides services for the second UE;
determining first information, wherein the first information is configured to assist in switching from a first base station providing services for the first UE to the second base station; and
transmitting the first information to the first UE.

10. The handover method of claim 9, further comprising:
transmitting a broadcast to the first UE, wherein the broadcast carries information supporting relay services.

11. The handover method of claim 9, further comprising, before establishing the connection to the first UE and the second base station:
establishing a first connection to the first UE.

12. The handover method of claim 11, further comprising, after establishing the first connection:
determining a connection management state of the second UE; and
switching to a connection management-connected (CM-CONNECTED) state when the second UE is in a connection management-idle (CM-IDLE) state.

13. The handover method of claim 9,
wherein the connection to the first UE and the second base station is an access (AS) connection,
wherein the transmitting the first information to the first UE comprises:
transmitting the first information to the first UE via the AS connection, and wherein the first information comprises at least one of: an identifier of the second base station, a measurement value of the second base station, or an identifier of the second UE.

14. The handover method of claim 9, wherein the second UE is a relay UE, and the relay UE comprises a layer 2 UE-to-network relay UE.

15. A handover method, performed by a first base station and comprising:
receiving second information from a first user equipment (UE), wherein the second information comprises first information, and the first information is configured to assist in switching from the first base station providing services for the first UE to a second base station providing services for a second UE; and
switching from the first base station to the second base station based on the second information.

16. The handover method of claim 15, wherein the first information comprises at least one of: an identifier of the second base station, a measurement value of the second base station, or an identifier of the second UE.

17. The handover method of claim 15,
wherein the second information further comprises a handover instruction, and
wherein switching from the first base station to the second base station based on the second information comprises:
switching from the first base station to the second base station based on the handover instruction, wherein the handover instruction is generated by the first UE based on the first information.

18. The handover method of claim 15,
wherein the second information further comprises a handover request, and
wherein switching from the first base station to the second base station based on the second information comprises:
in response to the handover request, deciding to switch to the second base station based on the first information.

19. The handover method of claim 15, further comprising:
performing Xn-based handover process to complete a handover from the first base station to the second base station based on a presence of an Xn connection between the first base station and the second base station; or
performing N2-based handover process to complete a handover from the first base station to the second base station based on an absence of the Xn connection between the first base station and the second base station or based on a failure of the Xn-based handover process.

20-23. (canceled)

24. A communication device, comprising:
a transceiver;
a memory storing computer-executable instructions; and
a processor connected to the transceiver and the memory, respectively; wherein the computer-executable instructions, when executed by the processor, cause the processor to control transmitting and receiving of wireless signals of the transceiver and perform the handover method of according to claim 1.

25. (canceled)
